(19) United States
(12) Patent Application Publication
(10) Pub. No.: US 2013/0246193 A1
(43) Pub. Date: Sep. 19, 2013

(54) METHODS FOR PROMOTING AUTO RACING WITH A PROFESSIONAL SPORTS LEAGUE

(71) Applicant: Ekrem Hakan Dinç, Kadikoy-Istanbul (TR)

(72) Inventor: Ekrem Hakan Dinç, Kadikoy-Istanbul (TR)

(21) Appl. No.: 13/420,427

(22) Filed: Mar. 14, 2012

(51) Int. Cl. G06Q 30/02

(52) U.S. Cl. 705/14.72

(57) ABSTRACT

A method for promoting an auto racing event and a professional sports league includes affiliating a racing association with a professional sports league. The professional sports league may comprise any type of sport, but not auto racing. A pool of automobiles is assembled for an auto-racing event sponsored by the racing association. Each automobile in the pool of automobiles is assigned to a club of the professional sports league so as to create a one-to-one association between automobiles in the automobile pool and the clubs of the professional sports league. Each automobile in the pool of automobiles is branded to represent the club associated with the automobile. Techniques are disclosed to promote both the professional sports league and the auto-racing event. The auto-racing event is conducted with the pool of automobiles so as to create a competition among the clubs of the professional sports teams with an auto-racing event.

### BACKGROUND OF THE INVENTION

1. Field of the Invention

The present invention is related to the field of marketing and promotion of sports, and more particularly to combining different sports for promotional benefits.

2. Background of the Invention

Professional sports are a huge business in the United States. Revenues are generated from media contracts with the professional teams, ticket sales for live events and from licensing of rights for merchandise sales. Currently, football is the most popular professional sport in the United States. National Football League (“NFL”) annual revenue is nearly $9 billion dollars. According to ESPN, average NFL game attendance is 66,957. The television rights to broadcast NFL games are the most expensive rights of any American sport. The terrestrial television networks, CBS, NBC and Fox, as well as cable television, ESPN, are paying a combined total of $20.4 billion, according to Sports Business Daily, to broadcast NFL games via its current contract that ends in 2013. According to ESPN, from 2014 to 2022, it is estimated that the same networks will pay $39.6 billion for the same broadcast rights.

Motorsports, on the other hand, is another popular sport in the United States. NASCAR annual revenue sums up to $645 million. NASCAR holds 17 of the top 20 attended single-day sporting events in the world and claims 75 million fans that purchase over $3 billion in annual licensed product sales.

The present invention provides for novel marketing and promotional methods to combine popular professional sports, such as professional football, and auto racing.

### SUMMARY OF THE INVENTION

A method for promoting an auto racing event and a professional sports league includes affiliating a racing association with a professional sports league. The professional sports league may comprise any type of sport, but not auto racing. A pool of automobiles is assembled for an auto-racing event sponsored by the racing association. Each automobile in the pool of automobiles is assigned to a club of the professional sports league so as to create a one-to-one association between automobiles in the automobile pool and the clubs of the professional sports league. Each automobile in the pool of automobiles is branded to represent the club associated with the automobile. Techniques may be used to promote both the professional sports league and the auto-racing event. The auto-racing event is conducted with the pool of automobiles so as to create a competition among the clubs of the professional sports teams with an auto-racing event.

In some embodiment, the professional sports league comprises the National Football League (NFL), the National Basketball Association (NBA), and Major League Baseball (MLB).

In some embodiments, the auto-racing event comprises conducting the auto-racing event in conjunction with an existing auto racing circuit. For example, the auto-racing event may be conducted in conjunction with a National Association for Stock Car Auto Racing (NASCAR) auto racing event or a Formula 1 Grand Prix auto-racing event.

In order to promote the club of the professional sports league, an automobile from the pool of automobiles may be exhibited in one or more locations of a home city for the club of the professional sports league for which the automobile was branded. In this way, the club may hold promotional events in one or more locations of the home city for the club. For example, an event may be held that brings together racecar drivers of the automobile for the club, players and people associated with the club, fans of the club and the auto-racing event.

In some embodiments, the pool of automobiles comprises open wheel racing cars. For this embodiment, the auto-racing event is conducted in accordance with IZOD Indy Cars Series regulations. In other embodiments, the pool of automobiles comprises a pool of touring cars. For this embodiment, the auto-racing event is conducted in accordance with FIA touring car regulations. In yet other embodiments, the pool of automobiles comprises NASCAR Sprint Cup Series cars. For this embodiment, the auto-racing event is conducted in accordance with NASCAR regulations.

In some embodiments, the auto-racing event is conducted to coincide with a season for the professional sports league.

In some embodiments, revenue of the auto-racing event is shared between the auto racing association and the clubs of the professional sports league.

In some embodiments, a promotional event is held to launch the auto-racing event with participation of personnel from both the auto racing association and the professional sports league.

### BRIEF DESCRIPTION OF THE DRAWINGS

The novel features of the invention are set forth in the appended claims. However, for purpose of explanation, several embodiments of the invention are set forth in the following figures.

FIG. 1 is an illustration of a car decorated as a football.

FIG. 2 illustrates a car (200) for use in the Autoleague NFL decorated with a logo (202) of the professional sports club “Jacksonville Jaguars.”

FIG. 3 illustrates two cars racing on a track for an AutoLeague NFL event.

FIG. 4 also illustrates two cars, decorated in colors and logos for two different NFL clubs, racing on a track for an AutoLeague NFL event.

FIG. 5 illustrates two cars at an Autoleague NFL racing event decorated with the Giants logo (503) and the Jaguars logos (502).

FIG. 6 illustrates an Autoleague NFL racing event with cars from all of the NFL clubs in participation at the event.

FIG. 7 illustrates an Autoleague NFL racing event at the track with corporate sponsors displaying their logos (“Sharpie” logo 704) and (“Hot Shot” logo 702).

FIG. 8 illustrates a race car for use in the Autoleague NFL with the “Green Bay Packers” logo 802 on both the hood and the side panel

FIG. 9 illustrates a race car for use in the Autoleague NFL with the “New York Jets” logo 902 on the hood, side panel and trunk.

FIG. 10 illustrates one embodiment for a promotional brochure to announce a race program for the Autoleague NFL.

FIG. 11 illustrates a race calendar for the AutoLeague NFL.

FIG. 12 illustrates promotional materials that depict an Indy style car decorated with the logo (1202) of the “Miami Heat.”

FIG. 13 illustrates promotional materials that depict an Indy style car decorated with the logo (1302) of the “Boston Celtics.”

FIG. 14 illustrates promotional materials that depict an Indy style car decorated with the logo (1402) of the “Houston Rockets” with a basketball pattern (1404).

FIG. 15 illustrates promotional materials that depict an Indy style car decorated with the logo (1502) of the “Los Angeles Lakers.”

FIG. 16 illustrates promotional materials that depict an Indy style car decorated with the logo (1602) of the “Chicago Bulls”, including a basketball pattern.

FIG. 17 illustrates promotional materials that depict an Indy style car decorated with the logo (1702) of the “Dallas Mavericks” logo as well as driver with a uniform that bears the same logo.

FIG. 18 illustrates promotional materials that depict an Indy style car decorated with the logo (1802) of the “New York Knicks.”

FIG. 19 is an illustration of a car decorated as a soccer ball.

FIG. 20 illustrates a car for use in the Autoleague associated with a professional soccer league decorated with logos (2002).

FIG. 21 illustrates a car for use in the Autoleague associated with a professional soccer league decorated with logo (2102).

FIG. 22 illustrates promotional materials that depict an emblem for the Auto League associated with a professional soccer league.

FIG. 23 illustrates a car for use in the Autoleague associated with a professional soccer league decorated with logo (2302).

FIG. 24 illustrates a car for use in the Autoleague associated with a professional soccer league decorated with logo (2202).

FIG. 25 illustrates promotional materials for a launch event for use in the Autoleague associated with a professional soccer league.

FIG. 26 is a flow diagram illustrating one embodiment for the method of promoting auto racing and a professional sports team.

### DETAILED DESCRIPTION

The present disclosure identifies methods and techniques to combine professional sports with auto racing that results in new and novel ways to market and promote both the professional sport as well as auto racing. For purposes of description, the present disclosure uses the term “Autoleague” to refer to an auto racing event that combines a professional sport, not related to auto racing, with auto racing. The Autoleague promotion of the present invention is a brand new track auto racing concept that brings all clubs of a professional sport together in a track race event. As described more fully below, the professional sport may be American football (e.g., NFL), American basketball (e.g., NBA), American baseball (MLB). However, any professional sport may be combined to create an Autoleague in conjunction with the teaching of the present invention without deviating from the spirit of scope of the invention.

In order to form the Autoleague, a racing association is affiliated with a professional sports league. For example, Safari Motorsports of Istanbul Turkey operates a racing garage and racecar driver school in Turkey. Safari Motorsports, given its expertise and knowledge of auto racing, may be the organizer and racing association of the Autoleague. The racing association assembles a pool of automobiles for an auto racing event. Then, each automobile in the pool of automobiles is assigned to a club of the professional sports league so as to create a one-to-one association between automobiles in the automobile pool and the clubs of the professional sports league. For example, if the professional sport is American football (NFL), the Autoleague track race event is organized by the attendance of thirty two (32) NFL football clubs such that each club is represented by a racing car. Each car in the pool of cars is branded to represent the club associated with the car. For the NFL example, each racing car is assigned to a football club and is branded with the color and logo of the football club. As such, an auto racing event creates a competition among all of the clubs of the professional sports teams in a single event. For the NFL example, all 32 NFL football clubs, each represented by a car, go head to head in a single auto racing event.

The Autoleague may be organized for sports franchises throughout the world. For example, the racing and sports promotion methods and techniques of the present invention may be organized for football clubs of England premiere league, Spanish La Lig, Italian Serie A, French Ligue 1 and German Bundesliga as well alongside with the Turkish super league.

In one embodiment, Autoleague brings together, for the first time, all clubs of a professional sports league in a single competition at the same time and on the same auto race track. For example, Autoleague NFL brings all 32 NFL football clubs in a single competition at the same time and on the same track. For this embodiment, there is no single matching between the clubs. Instead, competition among all of the clubs is organized in rounds on tracks across the United States, such as the Daytona International Speedway and Indianapolis Motor Speedway. In other embodiments, depending on demand, auto racing event rounds may join Formula One Grand Prix and or NASCAR race programs to increase synergy, between auto racing and the professional sports, even further.

The present invention provides synergy between auto racing and the affiliated professional sports league as well as a means to promote the professional sports leagues beyond racing. In one embodiment, the auto racing event follows the season of the professional sports team. In one embodiment, in order for the Autoleague to promote the professional sports teams, the racing cars are sent to the cities of the clubs when the race calendar permits. For various embodiments of this promotion, the race cars are exhibited in the stadium of the professional sports team, fan stores of the professional sports team, shopping malls and city centers in the city that the professional sports team resides. In various other embodiments for a promotion, the racing drivers attend special events and meet their fans together with team captains and players of the professional sports team.

The set or pool of racing cars used in the championship event is determined among a number of alternatives. For example, in some embodiments, the racing cars may be open wheel racing cars, the type used in Indy Car series, FIA tour cars or NASCAR Sprint Cup Series cars. In some embodiments, the Autoleague racing events are organized by the racing association in accordance with the international standards required by FIA touring car regulation or NASCAR rulebook, as appropriate for the type of cars used. Alternatively, if Indy type cars are used in any of the Autoleague racing events, the IZOD Indy Car Series rules would apply. In some embodiments, Autoleague is organized as 8 to 10 rounds in circuits. The professional sports clubs collect points according to their standings in the championship.

In other embodiments for promotional events related to the Autoleague, the professional sports clubs may arrange promotional events with the drivers of the car affiliated with the club. For example, the professional sports club may sponsor events with the driver of the club's racing car. Although the driver of the club's car may make contractual arrangements with the affiliated sports club, drivers are expected to meet with the criteria and requirements of the Autoleague as set forth in the terms of the racing association that organizes the Autoleague.

In some embodiments, the race calendar (i.e., scheduling of the circuit racing event) is made so as to follow the preseason, regular season and playoffs of the professional sports league. For example, for the NFL implementation (e.g., Autoleague NFL), the preseason of August, regular season of September October November and December as well as the playoffs in January would coincide with circuit racing events.

In some embodiments, the promotional synergy between auto racing and the affiliated professional sport is further enhanced by a launch event for the circuit auto racing event. In some embodiments, the launch event is organized with attendance of officials of the professional sports league and clubs. For the Autoleague NFL embodiment, the launch event may be organized with attendance of personnel, such as NFL officials, NFL sponsors, NFL clubs, team captain and players as well as the media. The launch promotional event permits an unveiling of all cars and racing drivers to attend a great show.

The present invention provides a means for a novel revenue and distribution model. In some embodiments, the proposed revenue sources for the Autoleague are: corporate sponsorships, national media deals (e.g., TV, radio, mobile and Internet), commercial licensing of merchandise (e.g., apparel, video games, and other official merchandise), ticket sales, concession sales and event parking. In some embodiments, revenues will be generated centrally and then distributed evenly among the clubs of the professional sports league, minus organizational expenses of the Autoleague. As such, Autoleague will provide a new revenue source for professional sports clubs and leagues while energizing the communication of its sponsors as a brand new marketing tool.

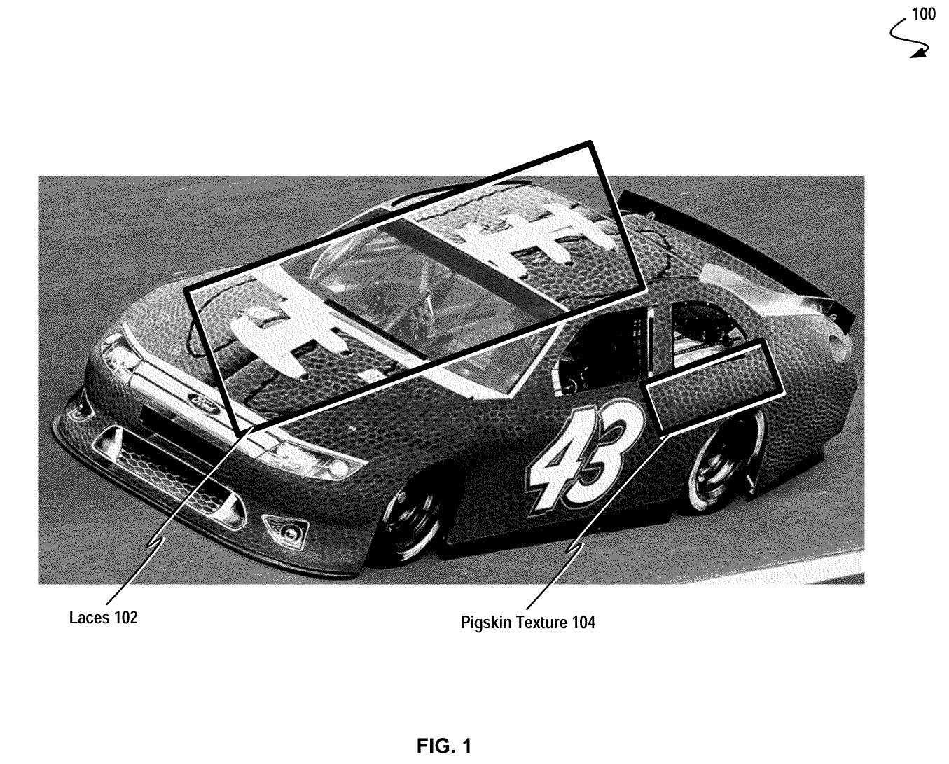

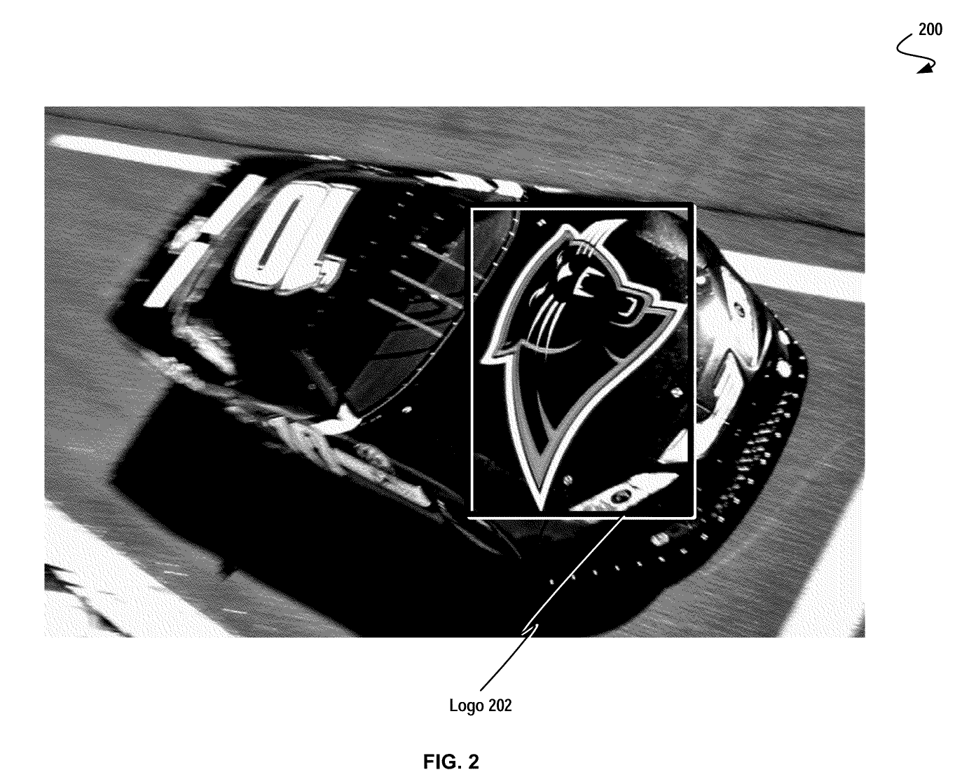

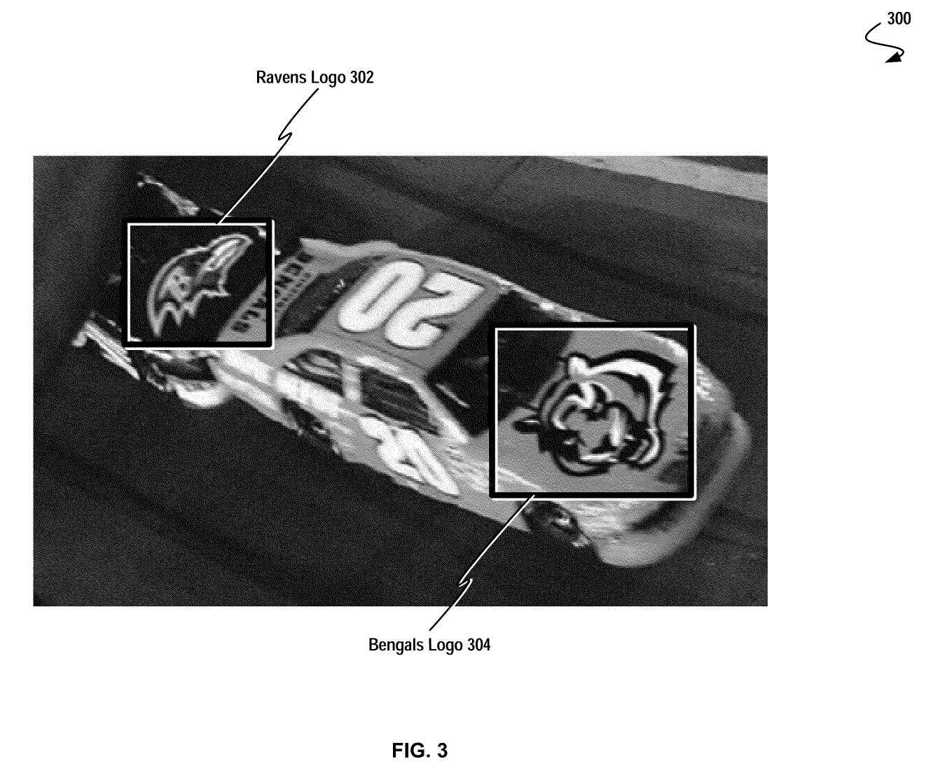

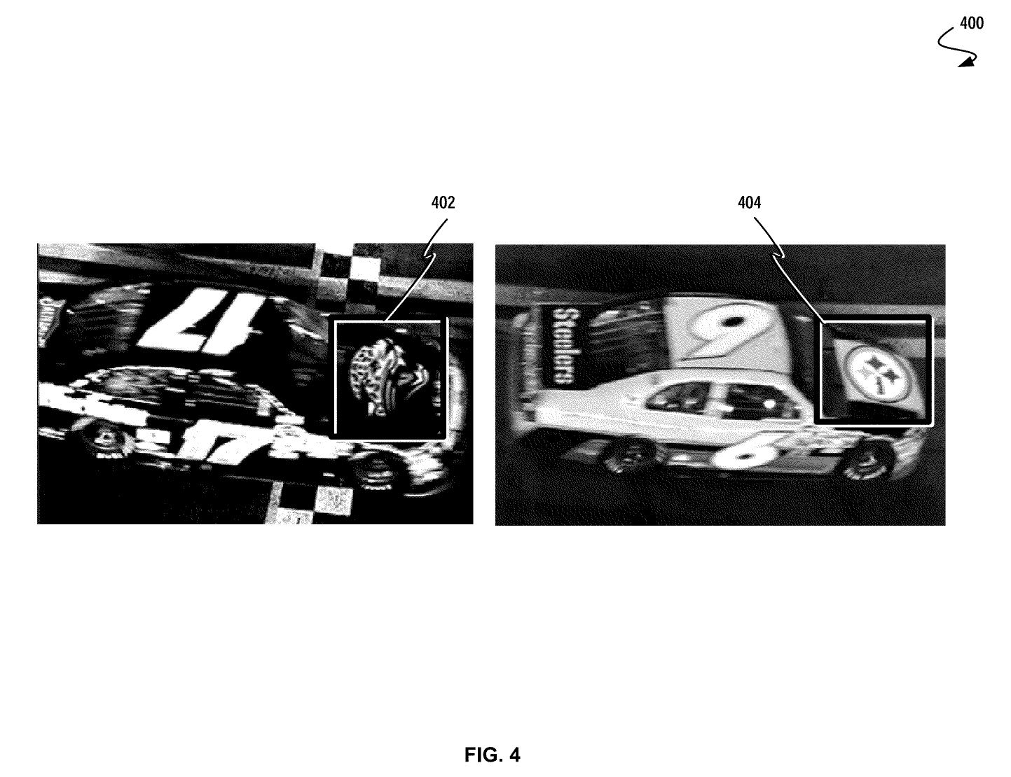

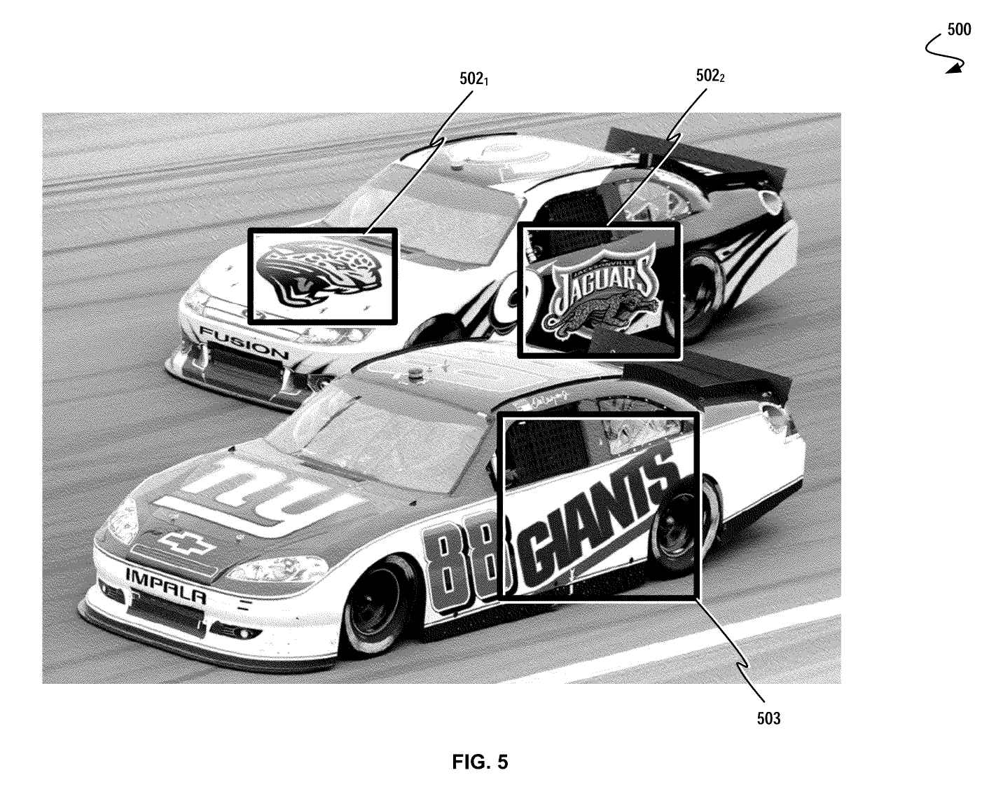

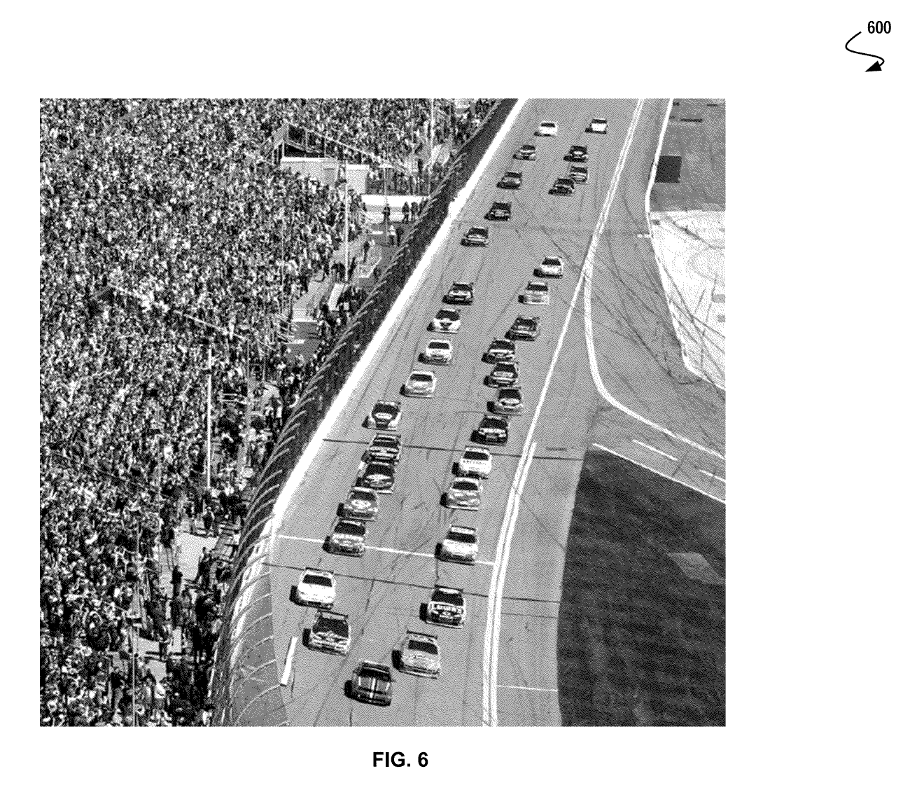

FIGS. 1 to 11 illustrate cars and example promotional materials for an Autoleague associated with the National Football League (“Autoleague NFL”). FIG. 1 is an illustration of a car decorated as a football. Specifically, the car of FIG. 1 is decorated to include laces (102) and covered in a pigskin texture (104). The car shown in FIG. 1 may be a pace car for the Autoleague NFL. FIG. 2 illustrates a car (200) for use in the Autoleague NFL decorated with a logo (202) of the professional sports club “Jacksonville Jaguars.” FIG. 3 illustrates two cars racing on a track for an AutoLeague NFL event. As shown in FIG. 2, one car is decorated with a Bengals logo (304) and the second car is decorated with a Ravens logo (302). FIG. 4 also illustrates two cars, decorated in colors and logos for two different NFL clubs, racing on a track for an AutoLeague NFL event. Specifically, for the illustration in FIG. 4, a Steeler logo (404) and colors are affixed to the lead car, and a Jaguar logo (402) and color are displayed on the second car. Similarly, FIG. 5 illustrates two cars at an Autoleague NFL racing event decorated with the Giants logo (503) and the Jaguars logos (502). FIG. 6 illustrates an Autoleague NFL racing event with cars from all of the NFL clubs in participation at the event.

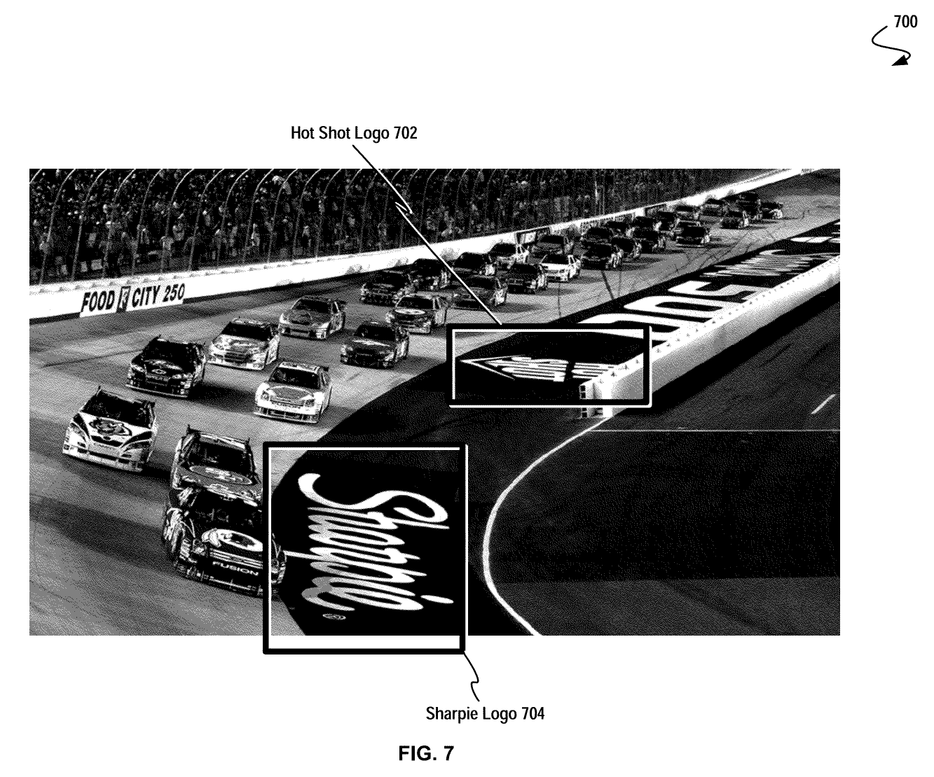

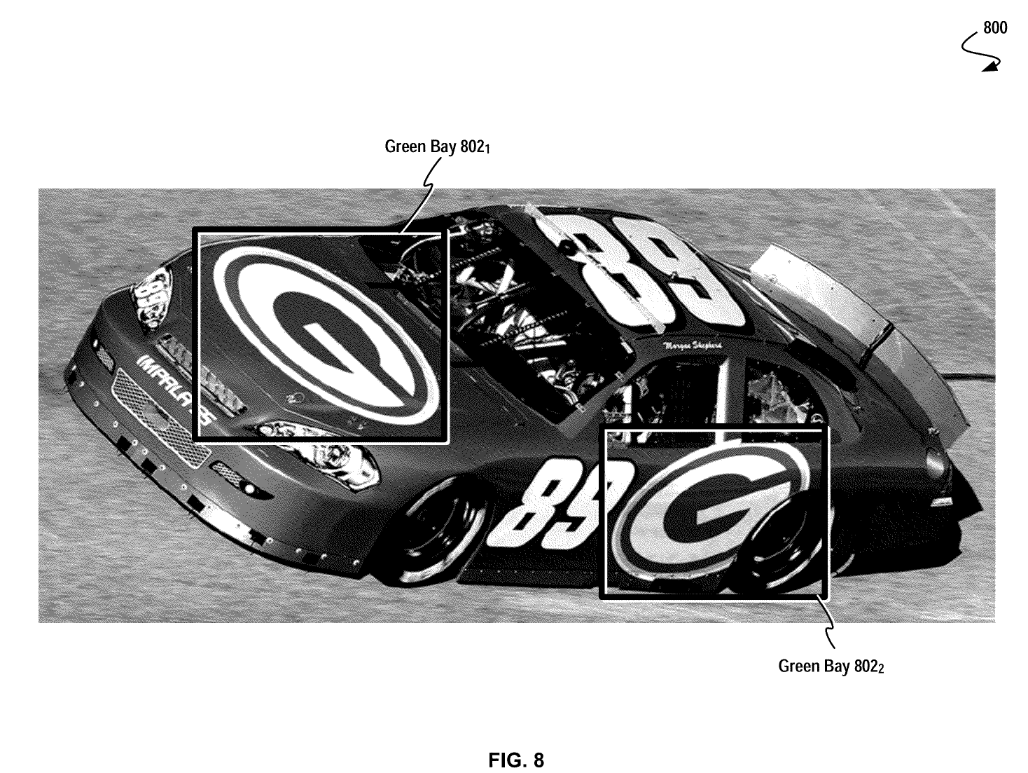

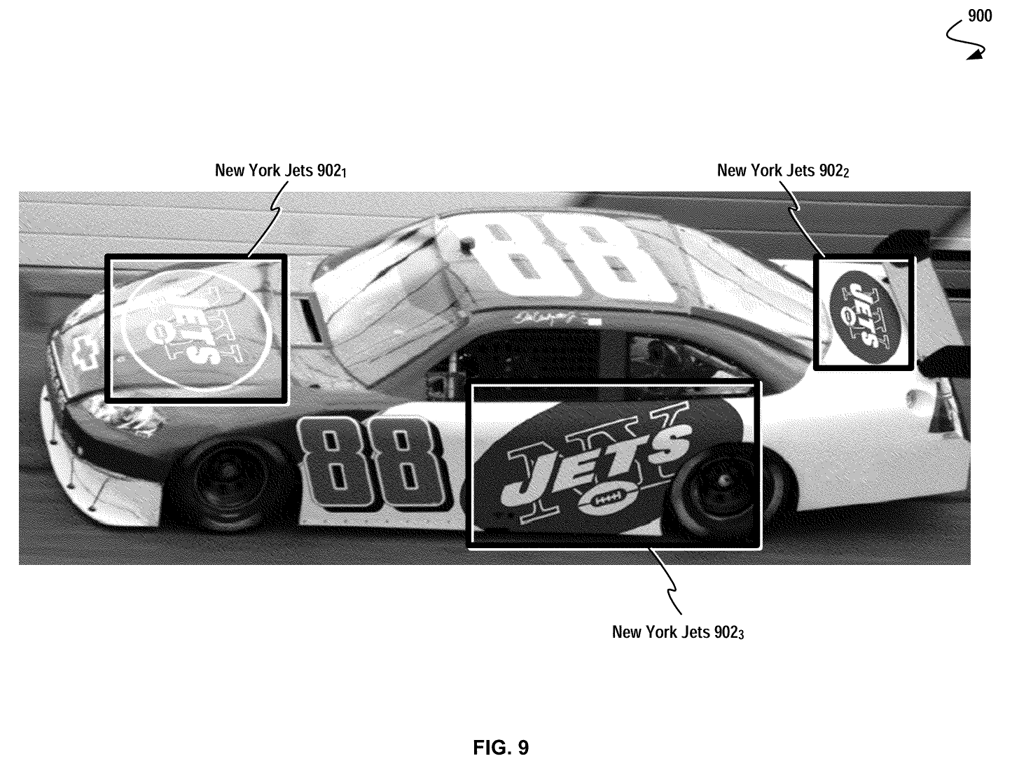

FIG. 7 illustrates an Autoleague NFL racing event at the track with corporate sponsors displaying their logos (“Sharpie” logo 704) and (“Hot Shot” logo 702). FIG. 8 illustrates a racecar for use in the Autoleague NFL with the “Green Bay Packers” logo 802 on both the hood and the side panel. Similarly, FIG. 9 illustrates a racecar for use in the Autoleague NFL with the “New York Jets” logo 902 on the hood, side panel and trunk.

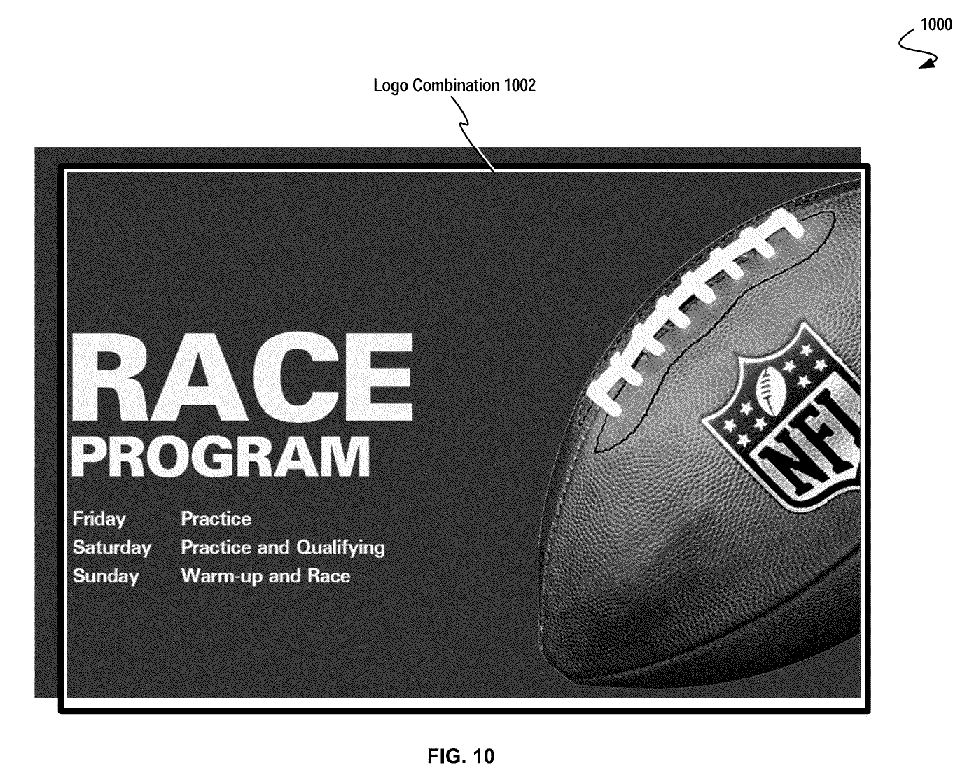

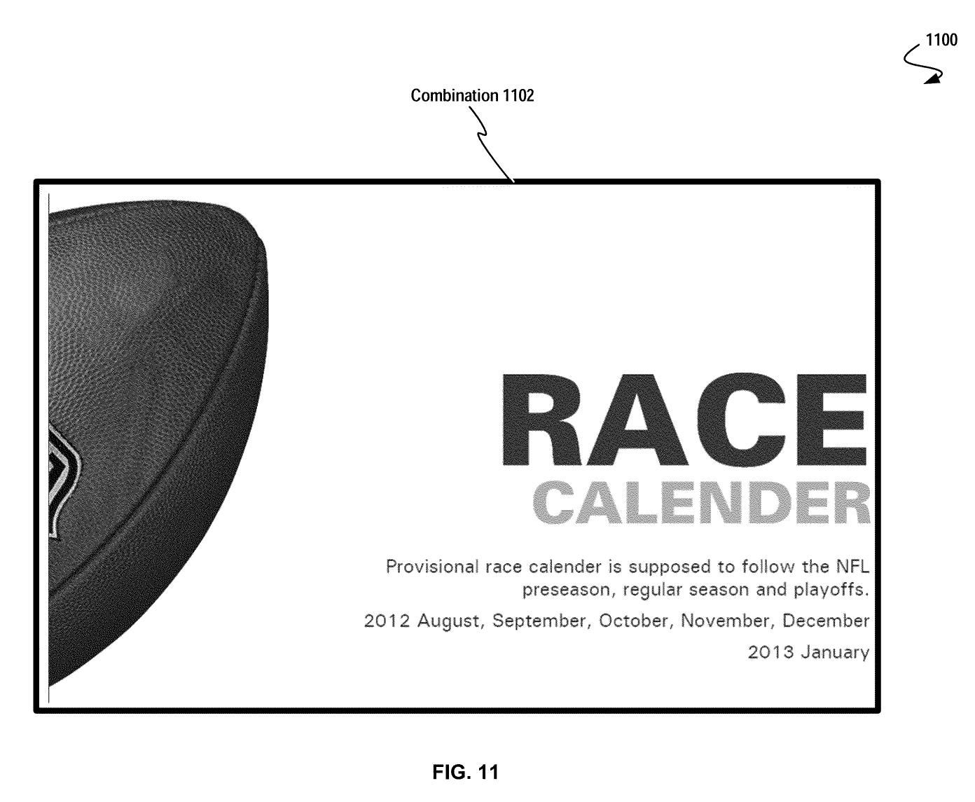

FIG. 10 illustrates one embodiment for a promotional brochure to announce a race program for the Autoleague NFL. As shown by the race program in FIG. 10, the auto-racing event commences with practice on Friday, practice and qualifying on Saturday leading to the warm-up and race on Sunday. FIG. 11 illustrates a race calendar for the AutoLeague NFL. As shown in the race calendar of FIG. 11, the race calendar follows the NFL preseason, regular season and playoffs.

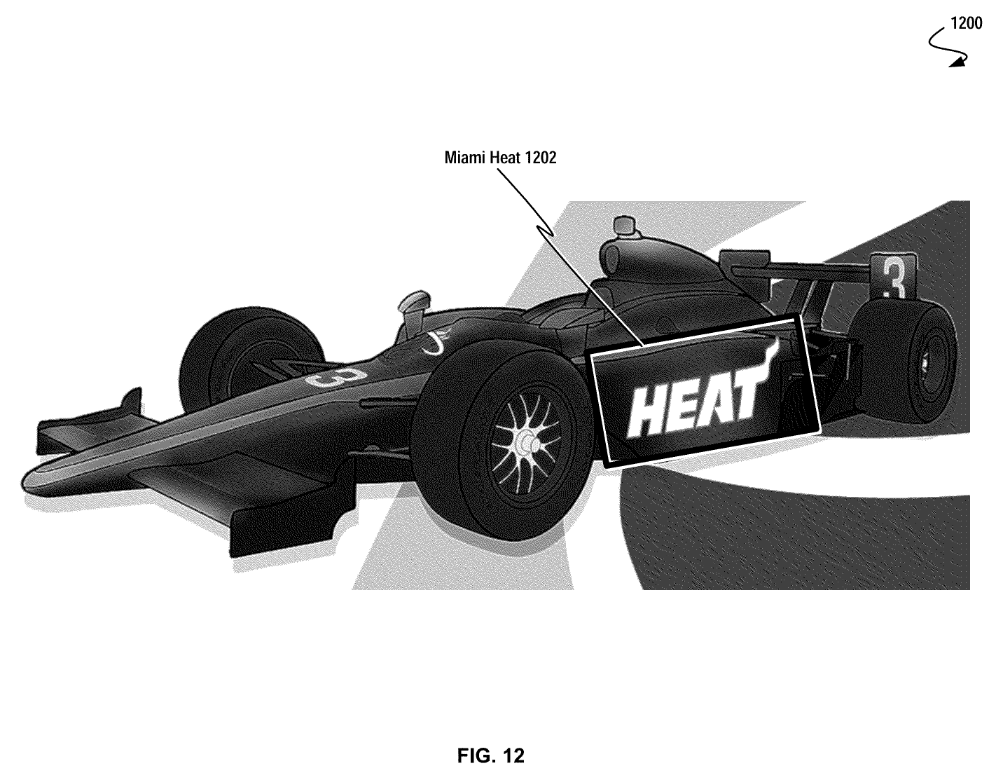

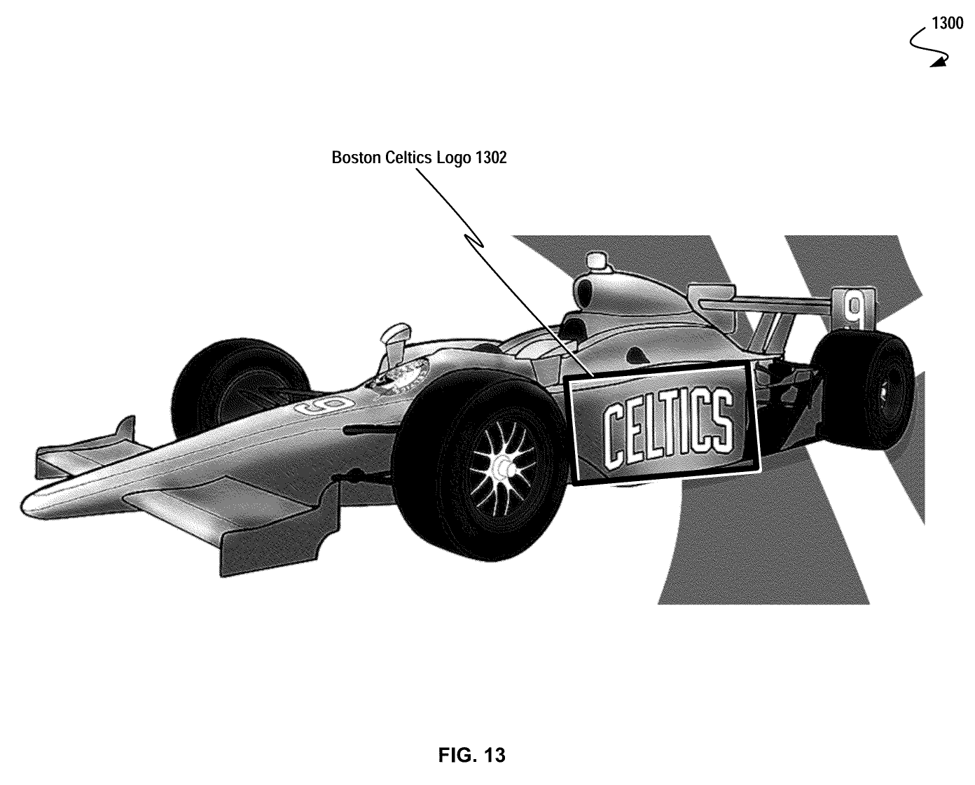

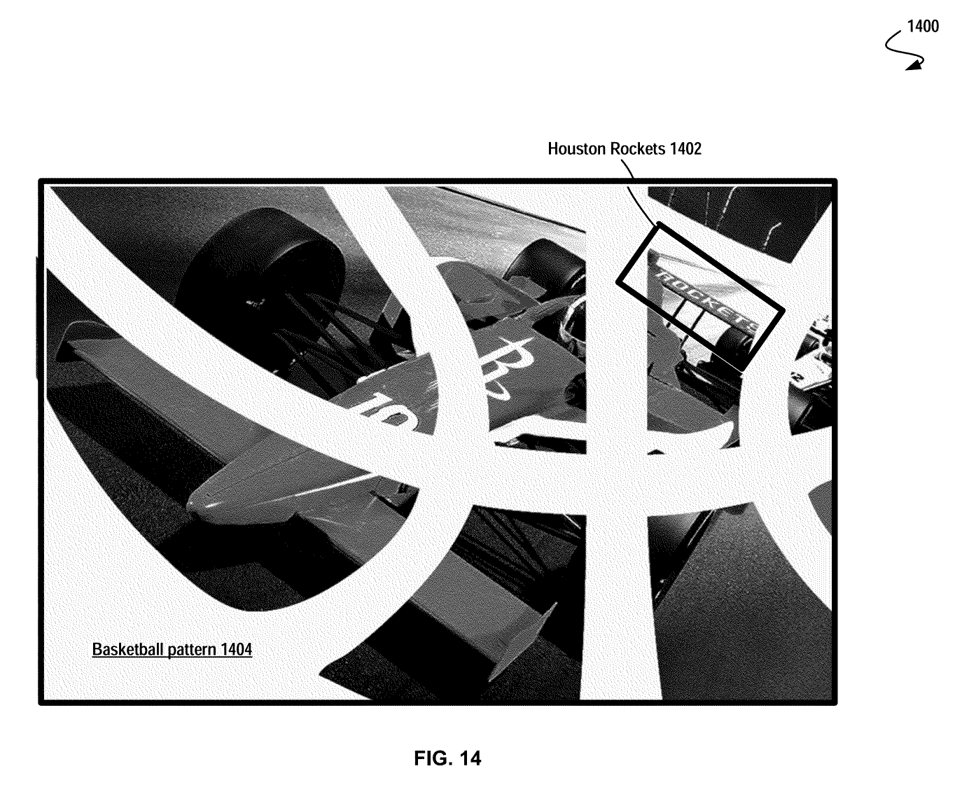

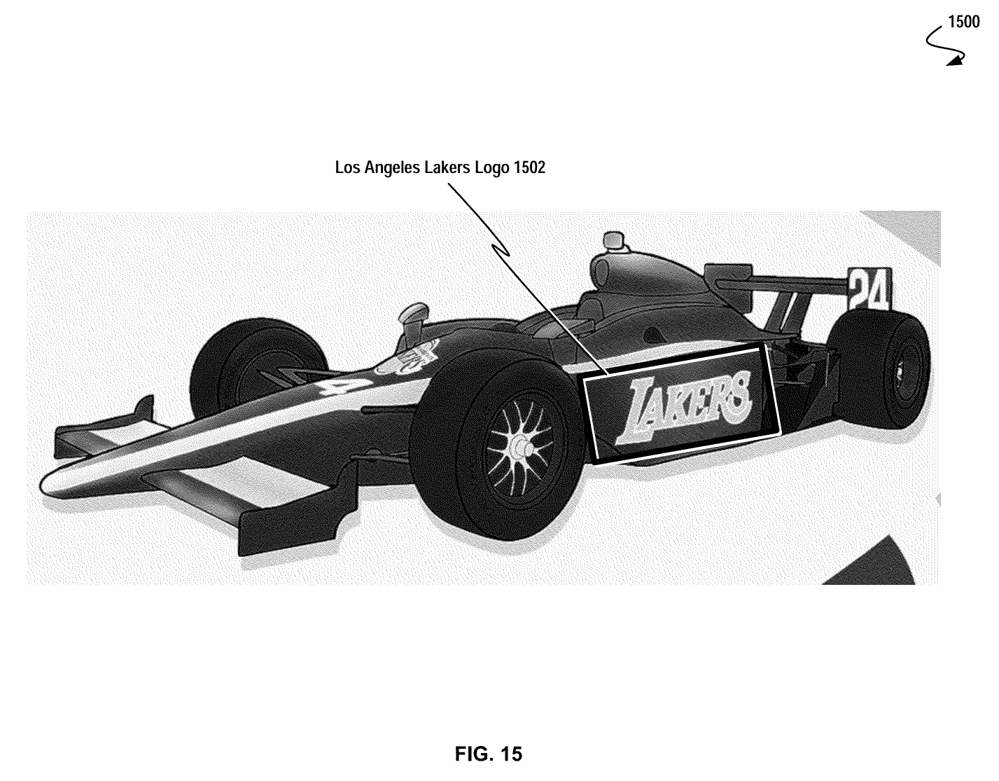

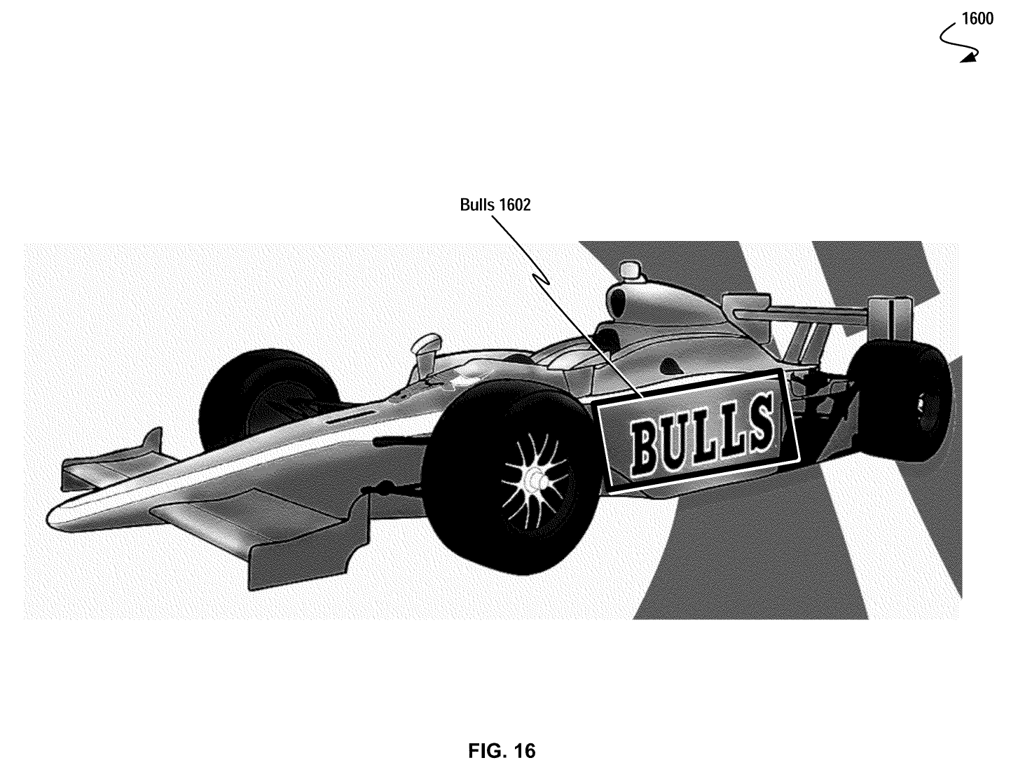

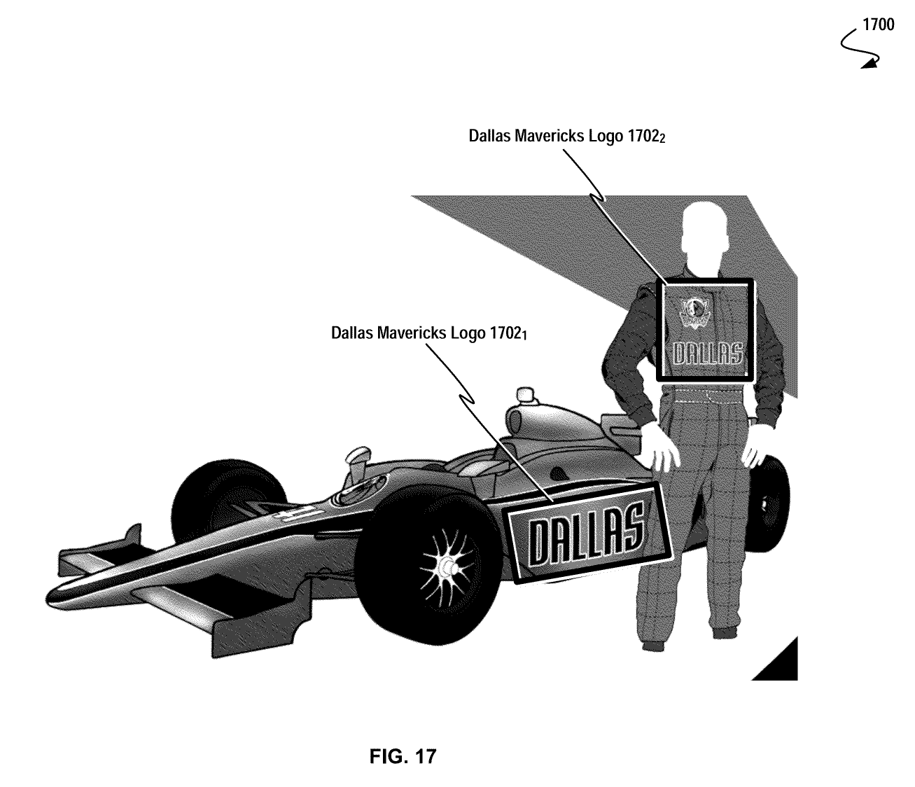

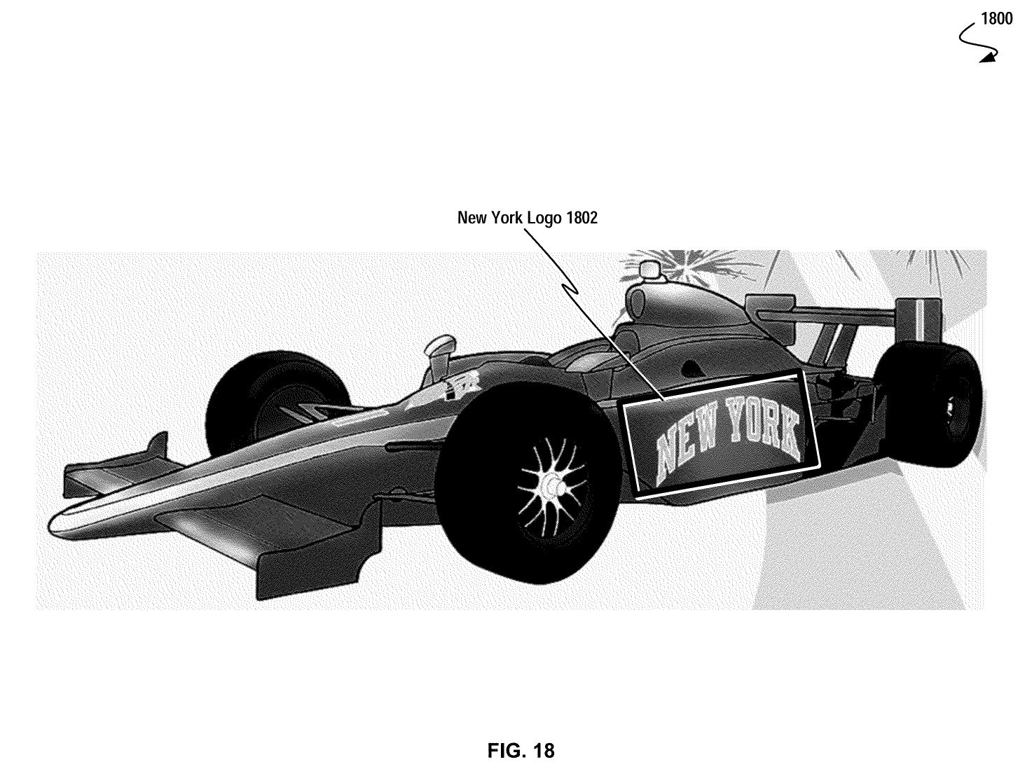

FIGS. 12 to 18 illustrate cars and example promotional materials for an Autoleague associated with the National Basketball Association (“Autoleague NBA”). FIG. 12 illustrates promotional materials that depict an Indy style car decorated with the logo (1202) of the “Miami Heat.” FIG. 13 illustrates promotional materials that depict an Indy style car decorated with the logo (1302) of the “Boston Celtics.” FIG. 14 illustrates promotional materials that depict an Indy style car decorated with the logo (1402) of the “Houston Rockets” with a basketball pattern (1404). FIG. 15 illustrates promotional materials that depict an Indy style car decorated with the logo (1502) of the “Los Angeles Lakers”, and FIG. 16 illustrates promotional materials that depict an Indy style car decorated with the logo (1602) of the “Chicago Bulls”, including a basketball pattern. FIG. 17 illustrates promotional materials that depict an Indy style car decorated with the logo (1702) of the “Dallas Mavericks” logo as well as a driver with a uniform that bears the same logo. FIG. 18 illustrates promotional materials that depict an Indy style car decorated with the logo (1802) of the “New York Knicks.”

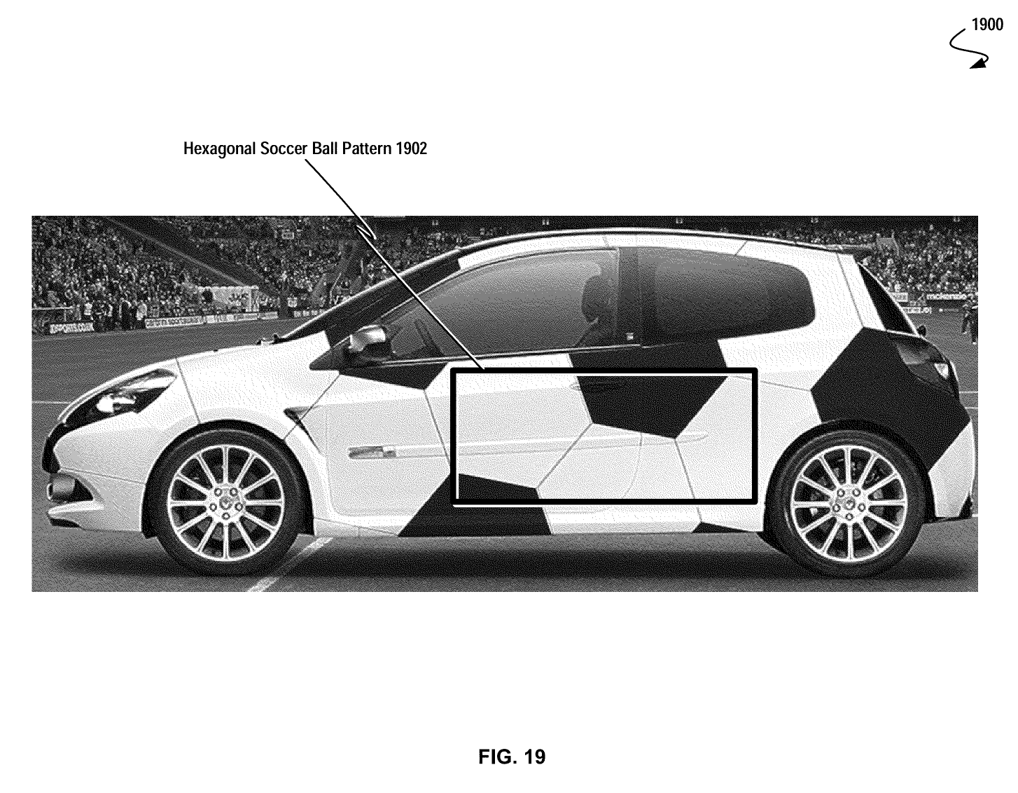

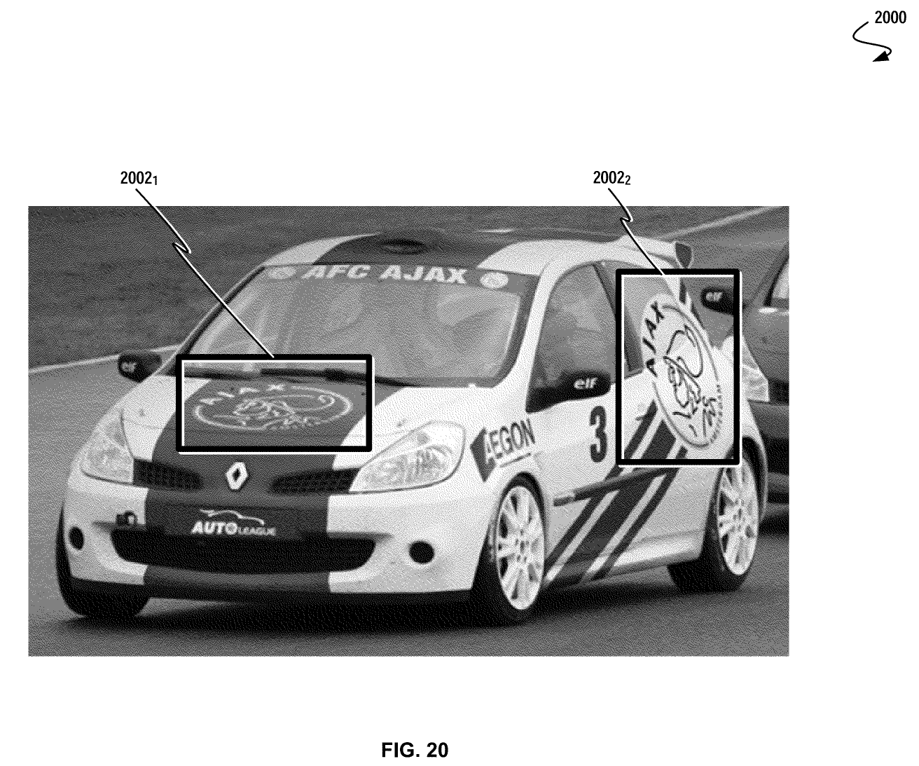

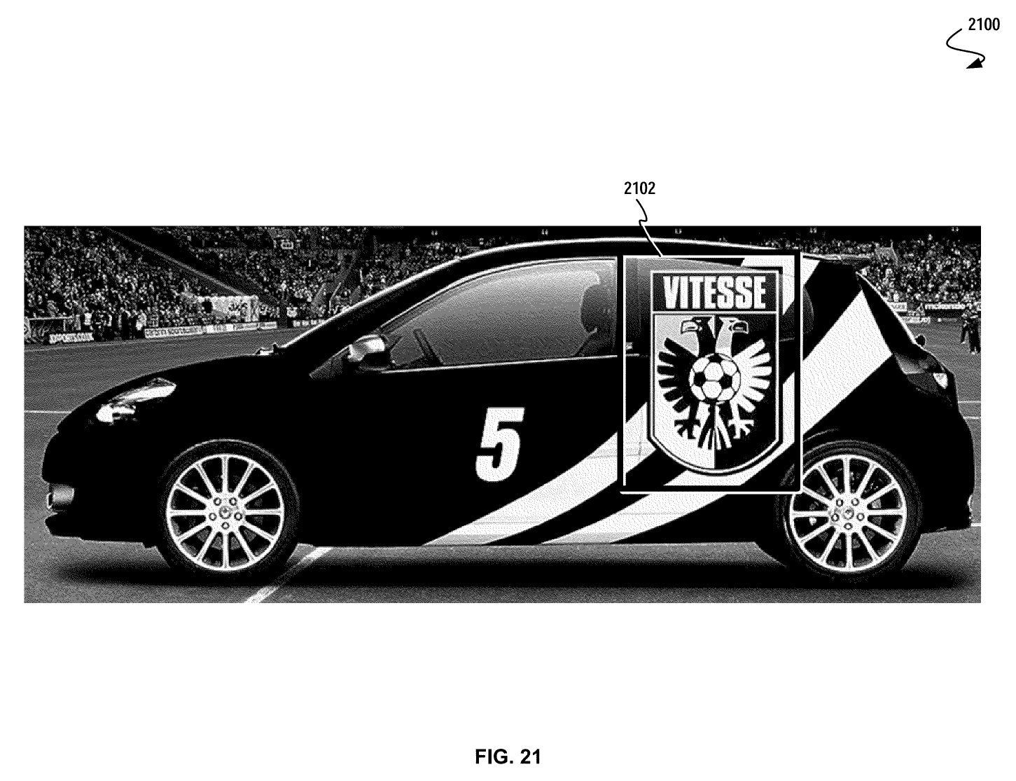

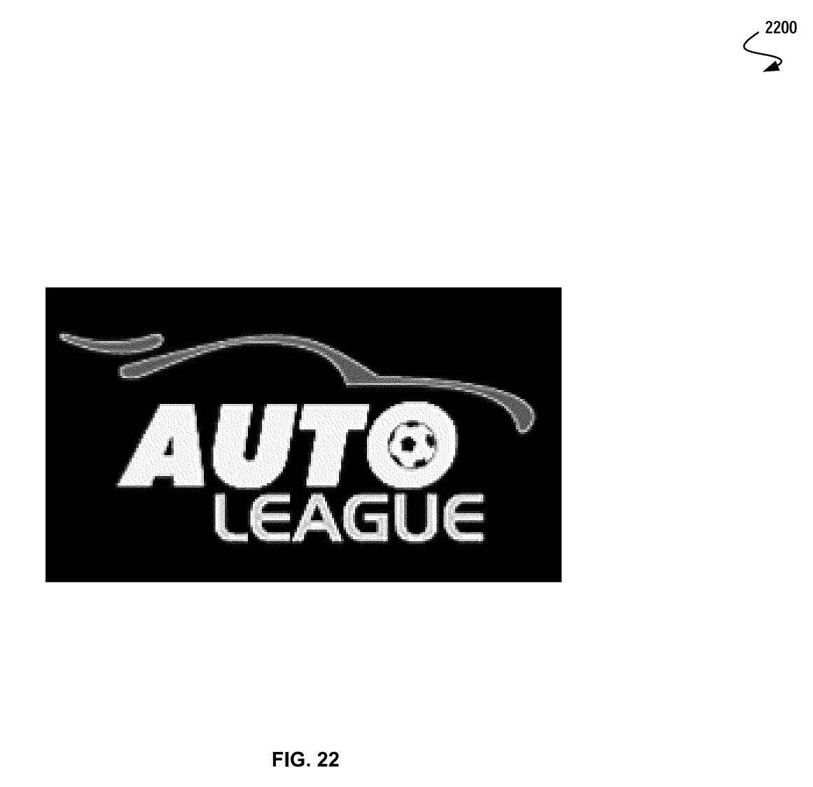

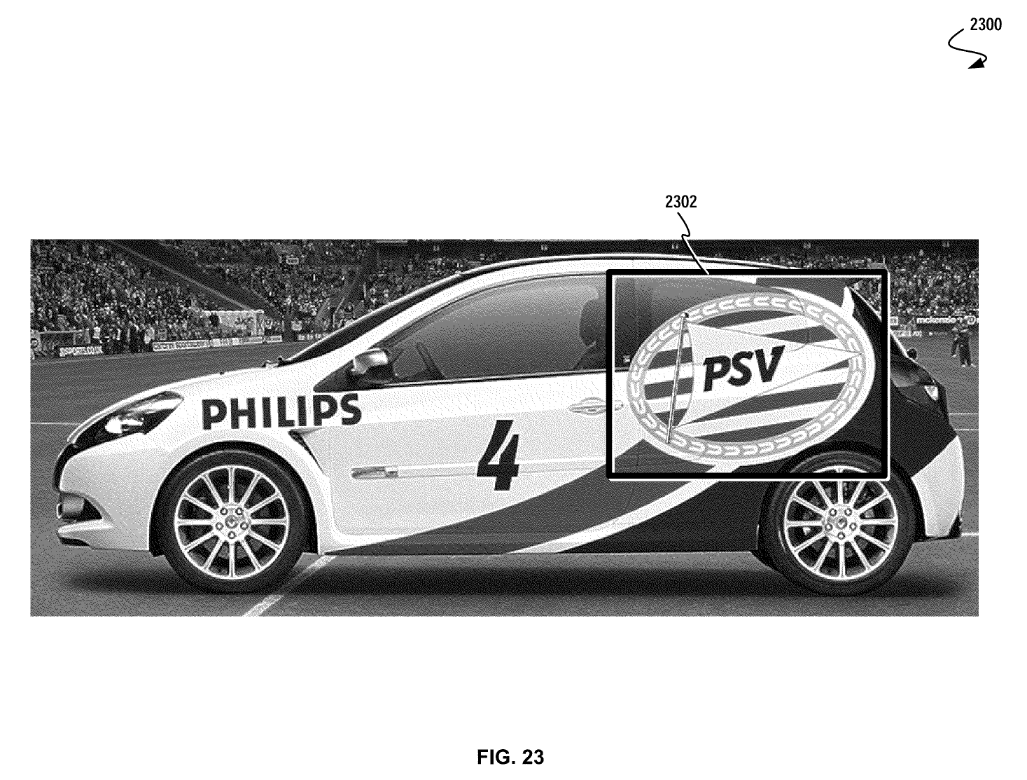

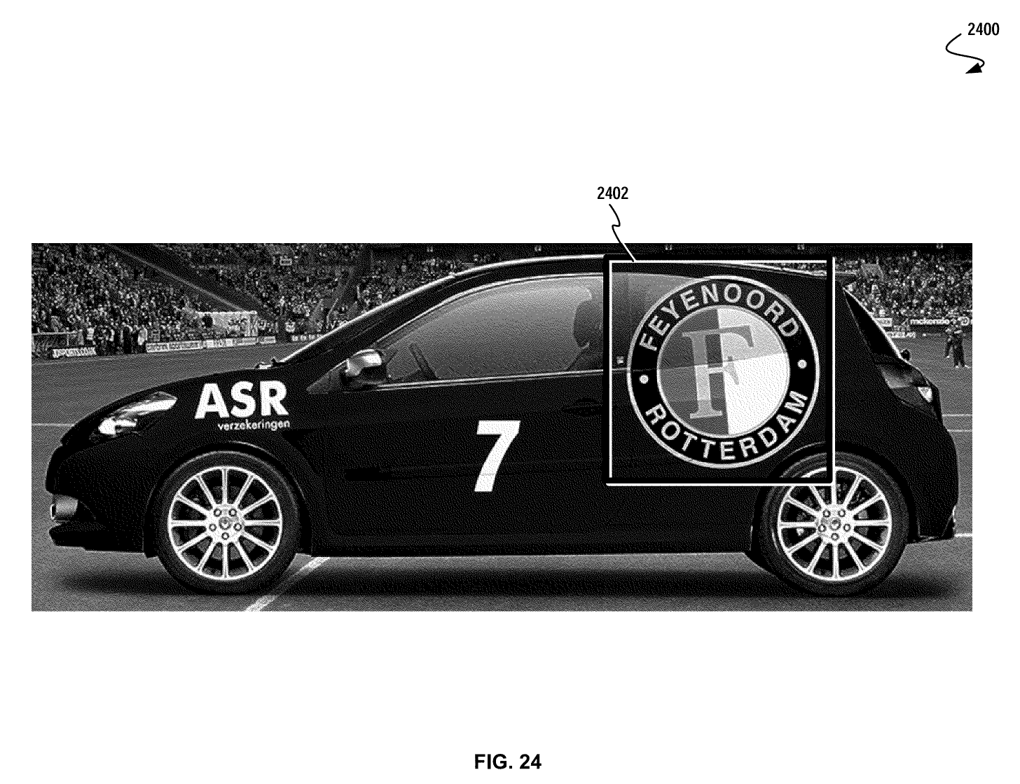

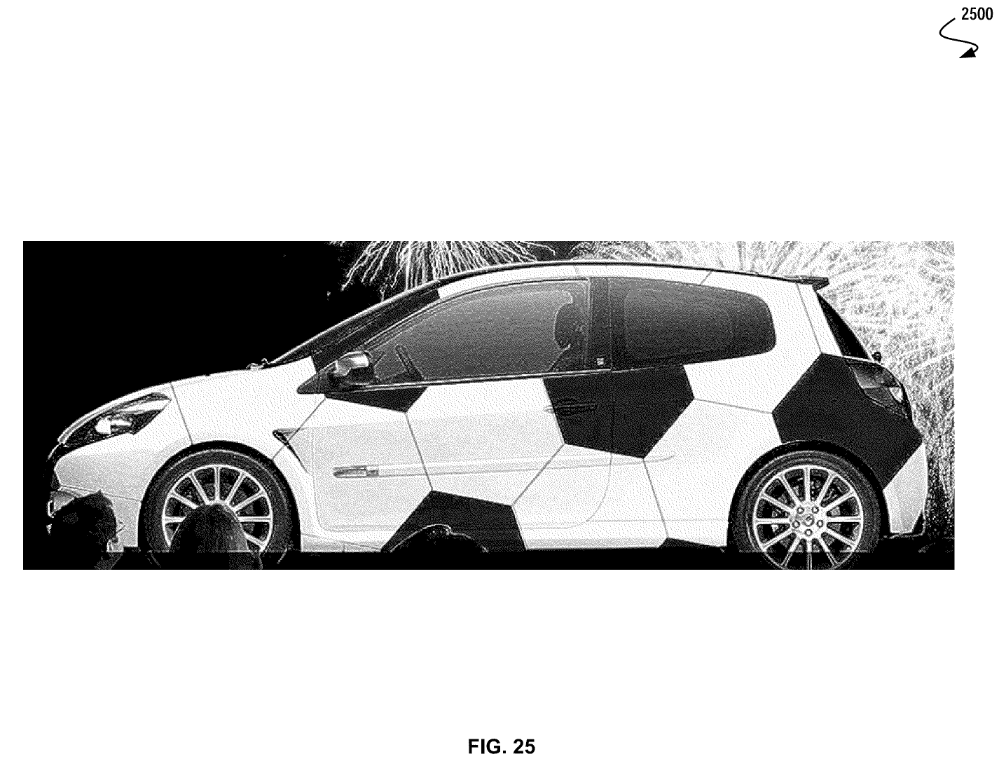

FIGS. 19 to 25 illustrate cars and example promotional materials for an Autoleague associated with a professional soccer league. FIG. 19 is an illustration of a car decorated as a soccer ball. FIG. 20 illustrates a car for use in the Autoleague associated with a professional soccer league decorated with logos (2002). FIG. 21 illustrates a car for use in the Autoleague associated with a professional soccer league decorated with logo (2102). FIG. 22 illustrates promotional materials that depict an emblem for the Auto League associated with a professional soccer league. FIG. 23 illustrates a car for use in the Autoleague associated with a professional soccer league decorated with logo (2302). Similarly, FIG. 24 illustrates a car for use in the Autoleague associated with a professional soccer league decorated with logo (2202). FIG. 25 illustrates promotional materials for a launch event for use in the Autoleague associated with a professional soccer league.

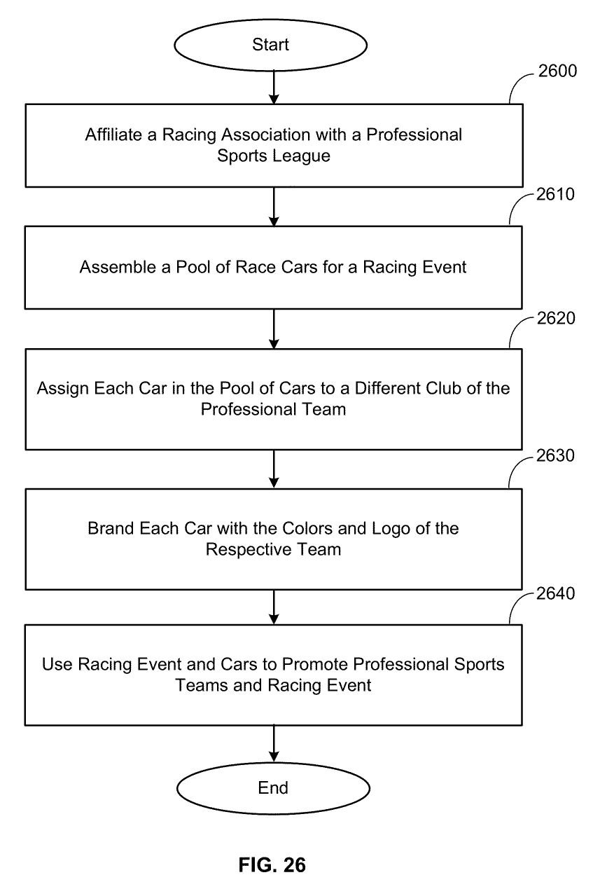

FIG. 26 is a flow diagram illustrating one embodiment for the method of promoting auto racing and a professional sports team. A racing association is affiliated with a professional sports league (2600). A pool of racecars are assembled for use in the auto-racing event (2610). Each car in the pool of cars is assigned to a different club of the professional league (2620). Then, each car is branded with the colors and the logo of the team assigned (2630). The auto racing event and the cars are used to promote professional sports clubs and the racing event (2640).

Although the present invention has been described in terms of specific exemplary embodiments, it will be appreciated that various modifications and alterations might be made by those skilled in the art without departing from the spirit and scope of the invention.

### Attribution of Trademarks

NFL is a registered trademark of the National Football League.

NBA is a registered trademark of the National Basketball Association.

MLB is a registered trademark of Major League Baseball.

NASCAR is a registered trademark of the National Association for Stock Car Auto Racing.

IndyCar is a registered trademark of an American-based open-wheel auto racing sanctioning body.

FIA is the registered trademark of Federation Internationale de l'Automobile.

Jacksonville Jaguars is the registered trademark of a professional American football team based in Jacksonville, Fla., United States.

Green Bay Packers is the registered trademark of a professional American football team based in Green Bay, Wis., United States.

New York Jets is the registered trademark of a professional American football team headquartered in Florham Park, N.J., representing the New York metropolitan area.

Miami Heat is the registered trademark of a professional basketball team based in Miami, Fla., United States.

Boston Celtics is the registered trademark of a professional basketball team based in Boston, Mass., United States.

Houston Rockets is the registered trademark of a professional basketball team based in Houston, Tex., United States.

Los Angeles Lakers is the registered trademark of a professional basketball team based in Los Angeles, Calif., United States.

Chicago Bulls is the registered trademark of a professional basketball team based in Chicago, Ill., United States.

Dallas Mavericks is the registered trademark of a professional basketball team based in Dallas, Tex., United States.

New York Knicks is the registered trademark of a professional basketball team based in New York City, N.Y., United States.

What is claimed is:

1. A method for promoting an auto racing event and a professional sports league, said method comprising:
affiliating a racing association with a professional sports league that comprises a plurality of clubs, wherein the professional sports league is not related to auto racing;
assembling a pool of automobiles for an auto-racing event sponsored by the racing association;
assigning each automobile in the pool of automobiles to a club of the professional sports league so as to create a one-to-one association between automobiles in the automobile pool and the clubs of the professional sports league;
branding each automobile in the pool of automobiles to represent the club associated with the automobile; and
conducting the auto-racing event with the pool of automobiles so as to create a competition among the clubs of the professional sports teams with an auto-racing event.

2. The method as set forth in claim 1, wherein the professional sports league comprises the National Football League (NFL®).

3. The method as set forth in claim 1, wherein the professional sports league comprises the National Basketball Association (NBA®).

4. The method as set forth in claim 1, wherein the professional sports league comprises a Major League Baseball (MLB®).

5. The method as set forth in claim 1, wherein conducting the auto racing event comprises conducting the auto racing event in conjunction with an existing auto racing circuit.

6. The method as set forth in claim 1, wherein conducting the auto racing event in conjunction with an existing auto racing circuit comprises conducting the auto racing event in conjunction with a National Association for Stock Car Auto Racing (NASCAR®) auto racing event.

7. The method as set forth in claim 1, wherein conducting the auto racing event in conjunction with an existing auto racing circuit comprises conducting the auto racing event in conjunction with a Formula 1 Grand Prix auto racing event.

8. The method as set forth in claim 1, further comprising exhibiting an automobile from the pool of automobiles in one or more locations of a home city for the club of the professional sports league for which the automobile was branded.

9. The method as set forth in claim 1, further comprising holding one or more promotional events in one or more locations of a home city for a club of the professional sports league affiliated with the racing association.

10. The method as set forth in claim 9, wherein holding one or more promotional events in one or more locations of a home city for a club of the professional sports league affiliated with the racing association comprises holding an event that brings together race car drivers of the automobile branded for a club of the professional sports league, players and people associated with the club and fans of the club and the auto racing event.

11. The method as set forth in claim 1, assembling a pool of automobiles comprises assembling a pool of open wheel racing cars.

12. The method as set forth in claim 11, wherein conducting the auto racing event comprising conducting the auto racing event in accordance with IZOD Indy Cars Series regulations.

13. The method as set forth in claim 1, assembling a pool of automobiles comprises assembling a pool of touring cars.

14. The method as set forth in claim 13, wherein conducting the auto racing event comprising conducting the auto racing event in accordance with FIA touring car regulations.

15. The method as set forth in claim 1, assembling a pool of automobiles comprises assembling a pool of NASCAR® Sprint Cup Series cars.

16. The method as set forth in claim 15, wherein conducting the auto racing event comprising conducting the auto racing event in accordance with NASCAR® regulations.

17. The method as set forth in claim 1, conducting the auto-racing event comprises conducting the auto-racing event to coincide with a season for the professional sports league.

18. The method as set forth in claim 1, further comprises sharing revenue of the auto-racing event between the auto racing association and the clubs of the professional sports league.

19. The method as set forth in claim 1, further comprising sponsoring a promotional event to launch the auto-racing event that includes participation of personnel from both the auto racing association and the professional sports league.

20. The method as set forth in claim 1, further comprises sponsoring one or more promotions for one or more clubs of the professional sports league during media coverage of the auto racing event.
